(19) United States
(12) Patent Application Publication
(10) Pub. No.: US 2006/0254237 A1
(43) Pub. Date: Nov. 16, 2006

(54) Agricultural combine

(76) Inventors: Jonathan E. Ricketts, Ephrate, PA (US); Robert A. Matousek, Milan, IL (US)

Correspondence Address: CNH AMERICA LLC, INTELLECTUAL PROPERTY LAW DEPARTMENT, 700 STATE STREET, RACINE, WI, 53404, US

(21) Appl. No.: 11/130,468

(22) Filed: May 16, 2005

(51) Int. Cl. A01D 34/00

(52) U.S. Cl. 56/14.6; 56/14.7

(57) ABSTRACT

An agricultural combine in which each of the front wheels and each of the rear wheels is driven by an independent fluid motor. The front wheels are steerable and the rear wheels are steerable, either independently or together. Regardless of the use mode in which the combine is operating the weight and balance characteristics of the combine for that use mode are such that the location of the CG is optimized.

### FIELD OF THE INVENTION

The present invention relates generally to agricultural combines. It relates particularly to the configuration and operation of self-propelled, agricultural combines.

### BACKGROUND OF THE INVENTION

A modern self-propelled agricultural combine of conventional design normally comprises a chassis supported by relatively large diameter front wheels, which are driven but not steerable, and relatively small diameter rear wheels, which are steerable, but not driven. The chassis supports a rotary threshing assembly and a grain tank. A power plant is mounted on the chassis behind the threshing assembly and tank. A body encloses the rotary threshing assembly, the power plant and a portion of the grain tank (which may protrude upwardly out of the body), and is also supported by the chassis. A grain harvesting header and feeder assembly is cantilevered from the chassis in front of the front wheels. The combine is operated from a cab mounted on the chassis above the header and feeder assembly and the front wheels.

When the combine is driven over the road between fields, for example, the header is normally removed. When it begins harvesting, the header and feeder assembly is mounted, but the grain tank is empty. As it harvests, the grain tank fills. Thus, the combine has different configurations for different “use modes”; configurations which change its weight and balance characteristics and, thus its centre of gravity (CG).

Regardless of the use mode, which the combine is operating in, the CG remains close to the front wheels in such conventional combines. As a result, whether the grain tank is empty and no header and feeder assembly is mounted, the grain tank is empty but the header and feeder assembly is operationally mounted, or the header and feeder assembly is operationally mounted and the grain tank is filled or filling, a large portion of the gross weight of the combine is supported by the front wheels.

A large combine with a header assembly and a full grain tank might weigh 60,000 (27,000 kg.) or more. Since a large portion of the weight is carried by the front wheels, and all of the driving force is transmitted through them, the front wheels can cause a substantial amount of ground disturbance, particularly when the combine is turning. Furthermore, power requirements for driving the combine under all conditions are higher because of the high front wheel loading. In addition, steering becomes less effective as weight is shifted almost entirely onto the front wheels as a result of the combine encountering unusual operating conditions.

Considerable efforts have been expended in the past to design a combine with more uniform weight distribution and improved operating characteristics, including lower power requirements. As early as 1973, some of these problems associated with conventional combines were addressed in U.S. Pat. No. 3,760,813. However, to date, no combine with greatly improved weight distribution and operating characteristics has been successful.

### SUMMARY OF THE INVENTION

It is an object of the present invention to provide a new and improved agricultural combine.

It is another object to provide an agricultural combine, which can operate efficiently with higher loads, using less power than conventional combines.

It is still an object to provide an agricultural combine, which has improved operating characteristics in all configurations and under all operating conditions.

It is another object to provide a four wheel drive agricultural combine with improved operating characteristics.

It is another object to provide a four wheel drive agricultural combine wherein steering may be effected through all four wheels, only the rear wheels or only the front wheels.

It is still another object to provide a four wheel drive, four wheel steering agricultural combine wherein all four wheels are substantially the same size.

It is yet another object to provide a four wheel drive, four wheel steering agricultural combine wherein each of the four wheels is independently driven by a fluid motor.

The foregoing and other objects are realised in accord with the present invention by providing an agricultural combine, which has four substantially equal diameter wheels, all of which are independently driven. Each of the four motors is driven by an independent fluid motor. The two front wheels are steerable, as are the two rear wheels. The front or rear wheels may be used independently to steer under different operating conditions, or both front and rear wheels may be used to steer at the same time, to make tighter turns, for example, or to “crab” the combine up a side-slope.

In the present invention, as in all combines, the four components which exert a primary effect on weight and balance (excluding the supporting chassis and wheels) are the header assembly, the cab, the axial threshing assembly, the grain tank and the combine's internal combustion power plant. In the present invention, however, they are arranged so as to optimise weight and balance in a combine which includes four driven wheels of substantially the same size, all of which are steerable. Regardless of the use mode in which the combine of the present invention is operating, weight distribution between front and rear wheels does not adversely affect operating characteristics.

### BRIEF DESCRIPTION OF THE DRAWINGS

The invention, including its construction and method of operation, is illustrated in the drawings, in which:

FIG. 1 is a side-elevational view of a combine embodying features of the present invention;

FIG. 2 is a top plan view of the combine seen in FIG. 1;

FIG. 3 is a top plan view, in simplified diagrammatic illustration, of the four-wheel drive and steering system for the combine seen in FIGS. 1 and 2;

FIG. 4 is a cross-sectional view of the planetary gear reduction unit shown in FIG. 3;

FIG. 5 is a side view of the combine seen in FIGS. 1 and 2 with the crop harvesting header assembly removed, the view being modified block diagram form to show weight distribution and CG characteristics in the use mode wherein the combine's grain tank is empty;

FIG. 6 is a side view, similar to FIG. 4, with the header assembly mounted in operational relationship and with the combine in the use mode wherein the grain tank is also empty; and

FIG. 7 is a side view, similar to FIG. 5, with the header assembly mounted in operational relationship and with the combine in the use mode wherein the grain tank is full.

### DETAILED DESCRIPTION OF A PREFERRED EMBODIMENT

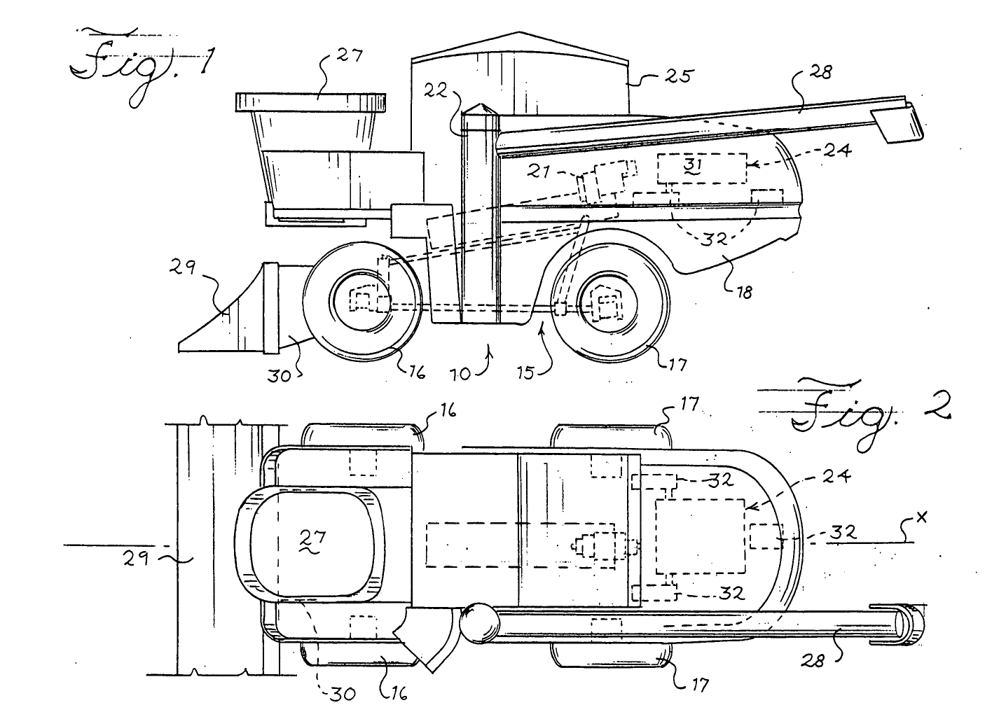

Referring now to the drawings, and particularly to FIGS. 1 and 2, an agricultural combine embodying features of the present invention is seen generally at 10. The combine 10 comprises a chassis 15 supported by two front wheels 16 and two rear wheels 17. Mounted on the chassis 15 is the combine body 18. Also mounted on the chassis 15, enclosed by the body 18, is a rotary threshing assembly 21, a grain handling assembly 22 and a power plant 24.

A grain tank 25 supported by the chassis 15 extends upwardly out of the body 18. Also outside the body 18, but mounted on the chassis, is an operator's cab 27 and an unloading conduit assembly 28. A crop harvesting header 29 and feeder assembly 30 is cantilevered forwardly of the front wheels 16 from the chassis 15.

In the embodiment of the combine 10 illustrated, the power plant 24 includes a 375 hp diesel engine 31 of conventional construction. The engine 31 drives hydraulic pumps 32 which, as a component of the power plant 24, supplies hydraulic power to drive the four wheels 16 and 17. The pumps 32 also supply hydraulic power to drive the threshing assembly 21, the grain handling assembly 22, the unloading conduit assembly 28, and the header 29 and feeder assembly 30.

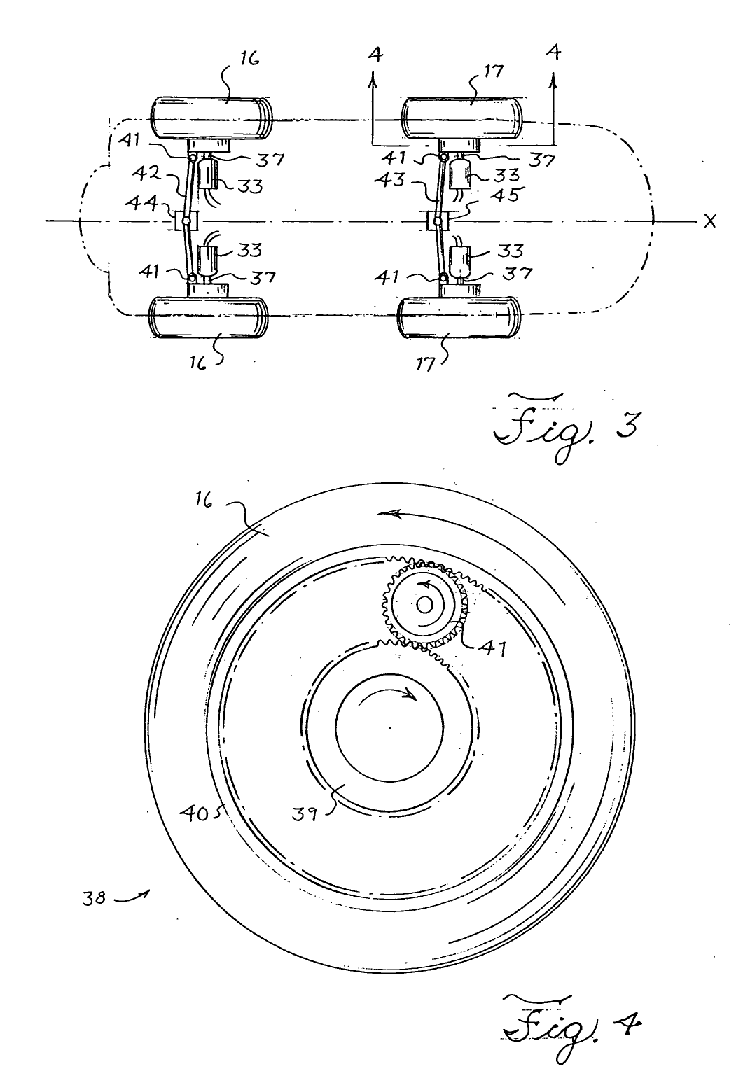

Referring now to FIG. 3, each of the front wheels 16 and each of the two rear wheels 17 is independently driven by an individual fluid motor 33. In the preferred embodiment of the combine 10 illustrated, each motor 33 is a Series 51, bent axis motor manufactured by Sauer-Sunderstrand. The output shaft 37 of each motor 33 is drivingly connected to a connected to a corresponding wheel through a separate, planetary gear reduction unit 38.

The front wheels 16 ands the rear wheels 17 on the combine 10 are substantially identical. In a preferred embodiment, for example, each wheel mounts a 24.5 inch, 12 ply, radial tire. Thus, each has a diameter of 64.8 inches (1646 mm) and a roll circle of 213.2 inches (5414 mm).

The front wheels 16 and the rear wheels 17 are independently steerable by the combine operator from the cab 27. Steering control rods 42 and 43 actuated by steering control motors 44 and 45 are effective to change the angle of the four wheels 16 and rear wheels 17 relative to the front-to-rear axis X of the combine 10 to effect steering at the direction of the operator. The front wheels 16 may be steered independently of the rear wheels 17, and vice versa, or both sets of wheels may be steered.

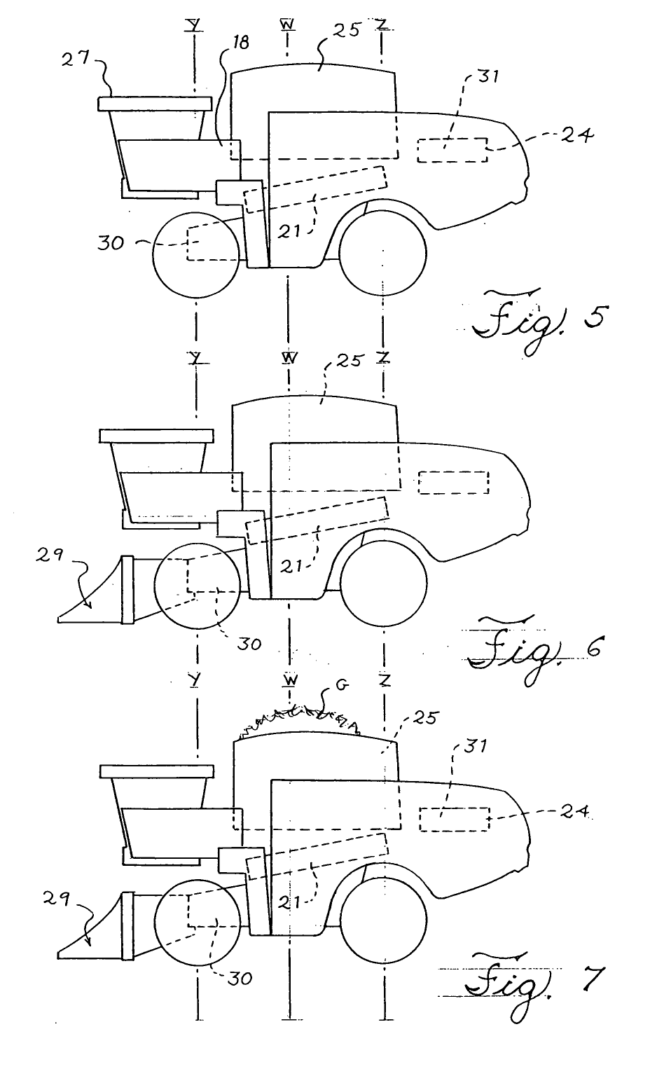

Referring now to FIG. 5-7, and first to FIG. 5, the combine 10 is illustrated without the header assembly 29. In this configuration, the combine weighs approximately 34,000 pounds (15,422 Kg) when it is empty, i.e., without any grain in the tank 25. According to the invention, in this configuration 40% of the weight of the combine 10 is carried by the front wheels 16 and 60% by the rear wheels 17.

As seen in FIG. 5, the CG for the combine 10 in this configuration is approximately 92 inches (2337 mm) rearwardly of a datum line through the centre of the front wheels 16. The weight, CG, and the moment arm of each major component of the combine 10 which affects the CG of the combine in this configuration is shown in FIG. 5.

Referring now to FIG. 6, the combine 10 is illustrated with the header assembly 11 mounted in operational relationship on the chassis 15. In this configuration, the combine 10 with header assembly 29 weighs approximately 42,000 pounds (19,090 Kg) when it's empty, i.e., without any grain in the tank 25. According to the invention, in this configuration 62% of this weight is carried by the front wheels 16 and 38% by the rear wheels 17.

As seen in FIG. 6, the CG for the combine 10 with its header assembly 29 in this configuration is approximately 58 inches (1476 mm) rearwardly of the datum line Y. Again, the weight, CG and moment arm of each major component of the combine 10 which affects the CG of the combine in this configuration is shown in FIG. 6. Although the front wheels 16 do carry a high percentage of the weight in this configuration, the combine only operates in this use mode at the very outset of a harvesting operation so ground disturbance is minimised. Since both front wheels 16 and rear wheels 17 are steerable, steering is not affected.

Referring now to FIG. 7, the combine 10 is illustrated with the header assembly 29 mounted in operational relationship on the chassis 18, and the grain tank 25 full. In this configuration, the combine 10 with header assembly 29 weighs approximately 62,000 pounds (28,123 Kg). According to the invention, in this configuration 56% of this weight is carried by the front wheels 16 and 44% by the rear wheels 17.

As seen in FIG. 6, the CG for the combine 10 with header assembly in this configuration is approximately 67 inches (1710 mm) rearwardly of the datum line Y. Once again, the weight, CG and moment arm of each major component of the combine 10 which affects the CG of the combine in this configuration is shown in FIG. 6.

The present invention is capable of being incorporated in a variety of embodiments, only one of which have been described. The invention may be embodied in other forms without departing from its spirit or essential characteristics. The described embodiment should be considered illustrative only and the scope of the invention is, therefore, indicated by the appended claims rather than by the foregoing description. All variations, which come within the meaning and scope of the claims, including the full range of equivalency to which they are entitled, are intended to be embraced within their scope.

1. A self-propelled agricultural combine, comprising:
a) a longitudinally extending chassis;
b) a pair of front wheels supporting a front end of said chassis and a pair of rear wheels supporting a rear end of said chassis;
c) all of said wheels being of substantially the same diameter;
d) a power plant mounted on said chassis; and
e) said front wheels and said rear wheels being driven by said power plant.

2. The combine of claim 1 further characterised in that:
a) said front wheels and said rear wheels are steerable

3. The combine of claim 2 further characterised by and including:
a) a separate fluid motor drivingly connected to each of said wheels;
b) said power plant supplying fluid under pressure to each of said fluid motors.

4. The combine of claim 3 further characterised in that:
a) said combine includes a crop harvesting header assembly mounted on said chassis so that its CG is in front of said front wheels;
b) a grain tank mounted on said chassis so that its CG is between said front wheels and said rear wheels, and
c) said power plant being mounted on said chassis so that its CG is behind said rear wheels.

5. The self-propelled agricultural combine, comprising:
a) a longitudinally extending chassis;
b) a pair of front wheels supporting a front end of said chassis and a pair of rear wheels supporting a rear end of sad chassis
c) an operator's cab mounted on said chassis in front of said front wheels;
d) all of said wheels being of substantially the same diameter;
e) a bent axis fluid motor drivingly connected to each of said wheels;
f) a power plant mounted on said chassis behind said rear wheels and connected to each of said fluid motors, said power plant including a fluid pump;
g) a front steering control mechanism for steering said front wheels and a rear steering control mechanism for steering said rear wheels;
h) said front and rear steering control mechanisms being controllable by an operator from said cab to steer said front wheels independently of said rear wheels, said rear wheels independently of said front wheels or said front and rear wheels simultaneously.
